(19) United States
(12) Patent Application Publication
(10) Pub. No.: US 2004/0002048 A1
(43) Pub. Date: Jan. 1, 2004

(54) Method and system for providing a virtual computer classroom

(76) Inventors: Matthew Thurmaier, New Smyrna Beach, FL (US); David Lash, Kansas City, MO (US)

Correspondence Address: THOMAS B. LUEBBERING, HOVEY WILLIAMS LLP, 2405 Grand, Suite 400, Kansas City, MO, 64108, US

(21) Appl. No.: 10/188,381

(22) Filed: Jul. 1, 2002

(51) Int. Cl. G09B 3/00

(52) U.S. Cl. 434/350; 434/362

(57) ABSTRACT

A virtual computer classroom (10) that allows an instructor to present a lesson to at least one student over a network (12). The network (12) allows the instructor and the student to be in different locations. The classroom (10) broadly comprises a target device (14) some aspect of which is the subject of the lesson, a remote access device (RAD) (16) for remotely interacting with the target device (14), a view server (18) for connecting the RAD (16) to the network (12), and a presentation server (20) for allowing the instructor to present the lesson to the student over the network (12). The classroom (10) may also include a remote power controller (RPC) (22) for cycling power to the target device (16). The student and the instructor preferably access the classroom (10) using a JAVA enabled browser (24,26).

### BACKGROUND OF THE INVENTION

1. Field of the Invention

The current invention relates to virtual classrooms. More particularly, the current invention relates to a virtual computer classroom that allows an instructor to present a lesson to at least one student over a network.

2. Description of Prior Art

Traditional instructor-led training requires that instructors meet with students in a classroom. This format works very well and is commonly used; however, it requires instructors and students to be co-located.

Training that is more specialized may not draw many students located near qualified instructors. Therefore, either instructors must travel to students or students must travel to instructors, significantly increasing the costs of such training. Additionally, specialized training often requires specialized equipment which must be brought to and setup for each training session, further increasing the costs of such training.

However, people have become less willing to travel and travel budgets continue to diminish. Therefore, it is becoming increasingly difficult for students to attend training they need, especially training on emerging and specialized technologies.

Students prefer instructor-led training with “hands-on” lab exercises, since alternative methods, such as “self-paced” materials, are generally considered inadequate. Therefore, students need instructor-led training with “hands-on” lab exercises without being required to travel.

To alleviate some of the above problems, several methods have been developed to reproduce a lecture/demonstration portion of training with live instructors over a network. For example, there are currently many methods that provide video and audio connectivity from an instructor to students in order to reproduce the lecture/demonstration portion of training. However, these methods cannot reproduce “hands-on” lab exercises as experienced by students physically attending a class, especially the ability for an instructor to look at the progress of a student and show them how to overcome any difficulty they may have in completing the lab exercise.

Accordingly, there is a need for an improved virtual computer classroom that overcomes the limitations of the prior art.

### SUMMARY OF THE INVENTION

The current invention overcomes the above-identified problems and provides a distinct advance in the art of virtual classrooms. More particularly, the current invention provides a virtual computer classroom that allows an instructor to present a lesson with “hands-on” lab exercises to at least one student over a network so that the instructor and the student may be in different locations.

The lesson can be used to teach the student any number of topics. While the classroom is preferably used with one lesson at a time, the classroom may be used with several lessons, one right after another, with very little time between lessons. As discussed below, the lesson may comprise any combination of teaching techniques, including slide presentations, traditional lectures, question and answer sessions, individual “hands-on” lab exercises, group “hands-on” lab exercises, and instructor assisted lab exercises.

The lesson is preferably presented with the aid of electronic slides, such as those associated with Microsoft Powerpoint or KDE's K-Presenter. However, the lesson may be presented in any form, such as using an electronic whiteboard. Additionally, the lesson may be presented over a web-cam connection, thereby allowing the instructor to present the lesson in a traditional lecture format. While the instructor preferably prepares the lesson before it is presented to the student, any portion of the lesson may be presented to the student in real-time with little or no preparation.

The classroom broadly comprises: one or more target devices, some aspect of which is the subject of the lesson; a remote access device (RAD) for remotely interacting with the target device; a view server through which the RAD is connected to the network so that the instructor can monitor the student; and a presentation server for allowing the instructor to present the lesson to the student over the network. The classroom may also include a remote power controller (RPC) for controlling power to the target device.

The student preferably accesses the classroom using a JAVA enabled student browser, such as Microsoft Internet Explorer or Netscape Navigator. The student browser may access the view server and presentation server directly or through a web server. The student browser displays information received from the view server and presentation server in a view area and a presentation area, respectively. Information relating to the status of the target device is received from the view server and displayed in the view area of the student browser. The student interacts with the target device through the view area of the student browser. The lesson is received from the presentation server and displayed in the presentation area of the student browser. Additionally, a control area of the student browser preferably contains one or more buttons which initiate lesson-specific operations.

Clicking on one of the buttons in the control area of the student browser sends a uniform resource locator (URL) to the view server. The view server receives the URL and performs the operation associated with the button, such as initiating a connection to the target device through the RAD. Additionally, the view server may convert the URL into a command which may be executed within the view server or sent to the RAD or the RPC. For example, if the student clicks a button configured to cycle power to the target device, the student browser sends a specific URL to the view server. The view server converts the specific URL into a specific command and sends the specific command to the RPC. In response to the specific command, the RPC cycles power to the target device.

Furthermore, an instructor browser is similar to the student browser described above but may also be configured to access the view area of the student browser in order to provide assistance to the student. The instructor browser may also be configured with additional buttons for controlling the presentation server enabling the instructor to start, pause, fast-forward, rewind, dynamically change, and stop the lesson.

The target device is preferably some form of computing device, such as a personal computer (PC), a server, a telephone or network switch, a private branch exchange (PBX), a network router, or a personal data assistant (PDA). The target device may be virtually any device with some form of an embedded processor. Since the student will be performing lab exercises on the target device, the target device is preferably separate from any other element of the classroom, in order to ensure proper operation of the classroom.

The target device preferably includes any peripheral devices necessary to deliver the lesson. For example, in a system administration lesson that teaches the student how to configure additional hard disks, the target device typically includes at least one additional hard disk. Additionally, in a network administration lesson that teaches the student how to configure a router, the target device may include several PCs each with a network interface card (NIC) to simulate a network served by the router.

While the classroom can be used to teach the lesson to one student at a time, the classroom is preferably used to teach the lesson to several students simultaneously. Teaching the lesson to several students more efficiently uses the classroom and the instructor's time. Additionally, it is preferable for each student to be assigned their own target device or set of target devices, in order to more efficiently use everyone's time. This allows each student to perform operations on their own target device and not interfere with other students. Furthermore, the students may be in different locations, allowing the classroom to be used to teach a single lesson to any number of students anywhere they can each access the network.

While it is preferable for each student to have access to their own target device, a given lesson may utilize any number of target devices per student, including sharing a single target device among an entire set of students. For example, when the classroom is used to teach a lesson about a multi-user operating system, it may be acceptable for the entire set of students to share one target device, such as a shared server running the multiuser operating system. Alternatively, when the classroom is used to teach a lesson about system configuration, each student is preferably given their own target device because tasks, such as system configuration, can typically only be done by one student at a time on each target device.

Alternatively, when the classroom is used to teach a lesson about programming in a cross-development environment, there are preferably at least two target devices. A first target device is preferably a shared programming server that may be used to develop a program. A second target device is preferably a device for which the program is developed. In this case, more than one student may share the first target device, while each student is preferably assigned their own second target device so that each student may test their program without waiting for or impacting other students.

As an additional example, when the classroom is used to teach a lesson about a clustered operating system, the team of students is preferably assigned two or more target devices each running the clustered operating system. In this case, the team of students may learn about the clustered operating system as a group.

The RAD utilizes a bidirectional connection to the target device and allows remote interaction with the target device from power-on to power-off. The RAD receives status information from and transmits data and/or commands to the target device, thereby providing functionality that is normally only available to a person standing next to the target device. The RAD makes the status information available to the view server which presents the status information to the student through the student browser over the network. The browsers also send the commands to the target device through the RAD and the view server over the network, as described above.

The RAD may actually comprise two or more devices operating together. For example, a specific RAD may comprise a terminal server connected to a console serial port attached to the target device. In this case, the view server receives the status information from and sends the commands to the target device through the console serial port and the terminal server.

The view server preferably runs a view server software package, such as a Tarantella server software package available from Tarantella, Inc. The view server software package allows the view server to receive the status information from the RAD and transmit the status information to the browsers over the network, such that the status information may also be viewed by the instructor. The view server software package also allows the view server to receive the commands from the browsers and transmit the commands to the RAD and/or RPC, such that the commands may also be viewed by the instructor. In addition, the instructor may send commands to the RAD and/or RPC through the view server running the view server software package.

The presentation server preferably runs a presentation software package, such as Placeware, WebEx, or Centra Symposium. The presentation software package allows the presentation server to transmit the lesson to the browsers over the network.

Additionally, an audio connection between the instructor and the student is preferably also provided to allow the student to ask questions and the instructor to answer the questions. The audio connection may be managed by the presentation server or a separate teleconferencing system. For example, if the presentation software package does not provide an integral audio connection between the instructor and the student, then a common teleconference call connection may be used to provide the audio connection. Alternatively, a chat connection may be substituted for or used in conjunction with the audio connection.

The RPC allows the student to remotely turn the target device on and off by cycling power to the target device. The RPC is preferably a commonly available reboot strip that can be accessed through a LAN connection and/or a serial connection. The RPC preferably takes power from a power source, such as an uninterruptible power supply (UPS) and has one or more power ports from which the target device receives power.

It can be appreciated that the classroom may be located remotely with respect to the instructor and the student, since neither party needs physical access to the classroom. This allows the classroom to be used for different lessons conducted by different instructors in different locations with very little turn-around time, since no portion of the classroom needs to be shipped to the different locations. Additionally, this allows the classroom to be located in a cost effective location where technical support is readily available.

Furthermore, any element of the classroom may reside remotely with respect to other elements of the classroom. For example, the presentation server may be hosted by a presentation service provider. The presentation service provider may specialize in such services and only provide the functionality of the presentation server.

In use, for example, the classroom may be used to teach a lesson about configuring a NIC in a PC. In this case, the target device is the PC and the peripheral is the NIC. The instructor prepares the lesson comprising a plurality of electronic slides and uploads the slides to the presentation server. The instructor also prepares a lab exercise to reinforce the lesson. The instructor preferably uses the instructor browser to test the lesson and the lab exercise through the presentation server and the view server, respectively. Once the instructor is finished preparing and testing the lesson, as described above, he or she allows the student to log into the classroom, using the student browser.

Shortly before the lesson is scheduled to begin, the student and the instructor log into the classroom using the browsers, in a traditional manner commonly associated with network security. Once the student and the instructor have logged in, they are connected to the view server and the presentation server. The instructor uses the instructor browser to present the lesson through the presentation server. The student views the slides received from the presentation server in the presentation area of the student browser. Any questions the student may have are asked and answered through the audio connection or the chat connection.

In order to perform the lab exercise, the student controls the target device through the view server using the view area and the control area of the student browser. For example, the student may click a button in the control area which causes the view server to initiate a connection to the target device through the RAD. The student observes the status information concerning the target device through the RAD and the view server using the view area of the student browser. The student may also interact with the target device through the RAD and the view server by typing commands into the view area of the student browser.

The instructor monitors and controls the lesson using the presentation area and the control area of the instructor browser. The instructor can also observe the student's progression through the lab exercise through the view server using the view area of the instructor browser. Additionally, the instructor can assist the student in performing the lab exercise by taking control of the target device through the view server using the view area and the control area of the instructor browser.

### BRIEF DESCRIPTION OF THE DRAWINGS

A preferred embodiment of the present invention is described in detail below with reference to the attached drawing figures, wherein:

FIG. 1 is a block diagram of a preferred embodiment of a virtual computer classroom operable to allow an instructor to present a lesson to at least one student over a network;

FIG. 2 is a flow chart showing a method of preparing the lesson; and

FIG. 3 is a flow chart showing a method of presenting the lesson to the student.

### DETAILED DESCRIPTION OF A PREFERRED EMBODIMENT

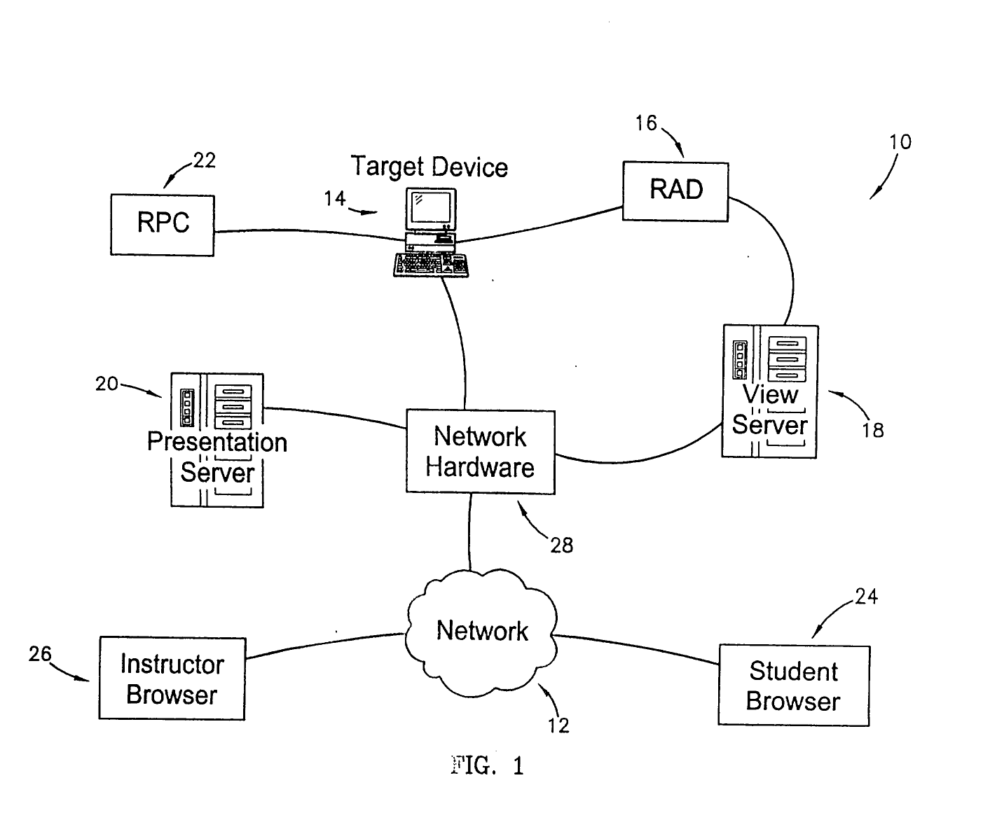

Referring to FIG. 1, a virtual computer classroom 10 constructed in accordance with a preferred embodiment of the current invention is illustrated along with computing equipment which may be used to implement certain aspects of the invention. The classroom 10 allows an instructor to present a lesson to at least one student and preferably resides on a network 12 accessible by both the instructor and the student. The network 12 is preferably the Internet, but may be a local area network (LAN), a wide area network (WAN), a virtual private network (VPN), or some combination thereof. The network 12 allows the instructor and the student to be in different locations, such as different rooms in the case of the LAN or different buildings in the case of the WAN or the Internet.

The lesson can be used to teach the student any number of topics. While the classroom is preferably only used with one lesson at a time, the classroom may be used with several lessons, one right after another, with very little time between lessons. As discussed below, the lesson may comprise any combination of teaching techniques, including slide presentations, traditional lectures, question and answer sessions, individual “hands-on” lab exercises, group “hands-on” lab exercises, and instructor assisted lab exercises.

The lesson is preferably presented with the aid of electronic slides, such as those associated with Microsoft Powerpoint or KDE's K-Presenter. However, the lesson may be presented in any form, such as using an electronic whiteboard. Additionally, the lesson may be presented over a web-cam connection, thereby allowing the instructor to present the lesson in a traditional lecture format. While the instructor preferably prepares the lesson before it is presented to the student, any portion of the lesson may be presented to the student in real-time.

The classroom 10 broadly comprises: one or more target devices 14, some aspect of which is the subject of the lesson; a remote access device (RAD) 16 for remotely observing and interacting with the target device 14; a view server 18 through which the RAD 16 is connected to the network 12, so that the instructor can observe the student; and a presentation server 20 for allowing the instructor to present the lesson to the student over the network 12. The classroom 10 preferably also includes a remote power controller (RPC) 22 for controlling power supplied to the target device 14 and/or other portions of the classroom 10, such as the RAD 16, the view server 18 and the presentation server 20.

The student preferably accesses the classroom 10 using a JAVA enabled student browser 24, such as Microsoft Internet Explorer or Netscape Navigator. The student browser 24 may access the view server 18 and the presentation server 20 directly or through a web server. The student browser 24 displays information received from the view server 18 and the presentation server 20 in a view area and a presentation area, respectively. Information relating to the status of the target device 14 is received from the view server 18 through the RAD 16 and displayed in the view area of the student browser 24. The student also interacts with the target device 14 through the view area of the student browser 24. As such, the view area preferably functions as an interface to the target device 14 that would normally be available to a person standing next to the target device 14. The lesson is received from the presentation server 20 and displayed in the presentation area of the student browser 24.

Additionally, a control area of the student browser 24 preferably contains one or more buttons which initiate lesson-specific operations. The control area may change as the lesson progresses thereby giving the student access to operations needed for each portion of the lesson.

Clicking on one of the buttons in the control area of the student browser 24 sends a uniform resource locator (URL) to the view server 18. The view server 18 receives the URL and performs the operation associated with the button, such as initiating a connection to the target device 14 through the RAD 16. For example, clicking one of the buttons in the control area may open a pop-up window which connects to the target device 14 through the RAD 16 and the view server 18 and thereby functions as the view area of the student browser 24.

Additionally, the view server 18 may convert the URL into a command which may be executed within the view server 18 or sent to the RAD 16 or the RPC 22. For example, if the student clicks a button configured to cycle power to the target device 14, the student browser 24 sends a specific URL to the view server 18. The view server 18 converts the specific URL into a specific command and sends the specific command to the RPC 22. In response to the specific command, the RPC 22 cycles power to the target device 14.

Furthermore, an instructor browser 26 is similar to the student browser 24 described above but can also be configured to access the view area of the student browser 24 in order to provide assistance to the student. The instructor browser 26 may also be configured with additional buttons for controlling the presentation server 20 enabling the instructor to start, pause, fast-forward, rewind, dynamically change, and stop the lesson.

As discussed above, the classroom 10 preferably resides on the network 12. Therefore, the classroom 10 necessarily includes some form of network hardware 28. When the network 12 is configured as the LAN, the network hardware 28 may be limited to a network hub or switch. However, when the network 12 is configured as the WAN or the Internet, the network hardware 28 will most likely include one or more routers.

The classroom 10 is preferably used to teach the student about the target device 14. Therefore, at least some aspect of the target device 14 is the subject of the lesson. The target device 14 is preferably some form of a computing device, such as a personal computer (PC), a server, a telephone or network switch, a private branch exchange (PBX), a network router, or a personal data assistant (PDA). Additionally, the target device 14 may be any device that includes some form of an embedded processor which performs computing functions

Since the student will be performing lab exercises on the target device 14, the target device 14 is preferably separate from any other element of the classroom 10. For example, if the student, who is learning about the target device 14, were to make an error in configuring a target device 14 that was also being used as the network hardware 28, the classroom 10 may become inaccessible.

The target device 14 preferably includes any peripheral devices necessary to deliver each lesson. For example, in a system administration lesson that teaches the student how to configure additional hard disks, the target device 14 typically includes at least one additional hard disk. Similarly, in a network administration lesson that teaches the student how to configure a router, the target device 14 may include several PCs each with a network interface card (NIC) to simulate a network served by the router. The target device 14 may also include peripherals, such as an external disk array, a network attached storage device (NAS), or a printer.

While the classroom 10 can be used to teach the lesson to one student at a time, the classroom 10 is preferably used to teach the lesson to several students simultaneously. Simultaneously teaching the lesson to several students more efficiently uses the classroom 10 and the instructor's time. Additionally, it is preferable for each student to be assigned a unique target device 14, in order to more efficiently use everyone's time. This allows each student to perform operations on their own target device 14 and not interfere with other students. Furthermore, each student may be in different locations, allowing the classroom 10 to be used to teach a single lesson to any number of students anywhere the network 12 can be accessed. Therefore, while FIG. 1 shows only one target device 14, it is to be understood that any number of target devices 14 may be used.

While it is generally preferable for each student to have access to their own target device 14, as discussed above, a given lesson may utilize any number of target devices 14 per student, including sharing a single target device 14 among a team of students. For example, when the classroom 10 is used to teach a lesson about a multi-user operating system, it may be acceptable for the team of students to share one target device 14, such as a shared server running the multiuser operating system. This is particularly useful if the lab exercises are designed to allow each student to perform them simultaneously. Alternatively, when the classroom 10 is used to teach a lesson about system configuration, each student is preferably given their own target device 14 because tasks, such as system configuration, can typically only be done by one student at a time on each target device 14.

Furthermore, when the classroom 10 is used to teach a lesson about programming in a cross-development environment, there are preferably at least two target devices 14. A first target device 14 is preferably a shared programming server that may be used to develop a program. A second target device 14 is preferably a device for which the program is developed. In this case, more than one student may share the first target device 14, while each student is preferably assigned their own second target device 14 so that each student may test their program without impacting other students.

As an additional example, when the classroom 10 is used to teach a lesson about a clustered operating system, the team of students is preferably assigned two or more target devices 14 each running the clustered operating system. In this case, the team of students may learn about the clustered operating system as a group.

The RAD 16 utilizes a bidirectional connection to the target device 14 and allows remote interaction with the target device 14 from power-on to power-off. The RAD 16 may be installed in or simply connected to the target device 14. The RAD 16 receives status information from and sends data and/or commands to the target device 14, thereby providing functionality that is normally only available to a person standing next to the target device 14, such as a power on self test (POST). The RAD 16 makes the status information available to the view server 18 which presents the status information to the student through the student browser 24 over the network 12. The browsers 24,26 also send the commands to the target device 14 through the RAD 16 and the view server 16 over the network 12, as described above.

The RAD 16 may actually comprise two or more devices operating together. For example, a specific RAD 16 may comprise a terminal server connected to a console serial port attached to the target device 14. The console serial port is a feature commonly available on high-end servers, such as Hewlett-Packard's 9000, Sun Microsystems' SparcServer, and International Business Machine's (IBM) AS/400. In this case, the view server 18 receives the status information through the console serial port and the terminal server.

As another example, a specific RAD 16 may comprise the terminal server connected to a PC-Weasel card installed in the target device, such as an IBM compatible PC. The PC-Weasel card is operable to turn non-graphic VGA output, such as text, into serial output and to turn serial input into keyboard inputs. In this case, the view server 18 receives the status information through the PC-Weasel card and the terminal server.

As still another example, a specific RAD 16 may comprise a proprietary remote console card, such as Compaq's Remote Insight Lights Out card, Intel's LANDesk card, or IBM's Remote Supervisor Adaptercard for Netfinity servers. These remote console cards typically communicate with a Microsoft Windows-based client application or a JAVA applet that provides control of the target device 14. In this case, the view server 18 preferably receives the status information from the remote console card by running the client application in a Microsoft Windows environment hosted by the view server 18 or in a JAVA Virtual Machine (JVM) of the browsers 24,26.

Furthermore, the RAD 16 may be an advanced remote console card which combines the functionality of the RAD 16 and the RPC 22. The advanced remote console card incorporates an independent power source, which provides power to the advanced remote console card when the target device's 14 power is turned off.

It may be possible for the student to connect to the RAD 16 without going through the view server 18; however, the student preferably connects to the RAD 16 through the view server 18. In this manner, the student's connection to the target device 14 can be observed by the instructor. The view server 18 also allows the student to observe as the instructor interacts with the target device 14 through the RAD 16 and the view server 18.

The view server 18 preferably runs a view server software package, such as a Tarantella server software package available from Tarantella, Inc. The view server software package allows the view server 18 to receive the status information from the RAD 16 and make the status information available to the browsers 24,26 over the network 12, such that the status information may also be viewed by the instructor. The view server software package also allows the view server 18 to receive the commands from the browsers 24,26 and transmit the commands to the RAD 16 and/or RPC 22, such that the commands may also be viewed by the instructor. In addition, the instructor may send commands to the RAD 16 and/or RPC 22 through the view server 18 running the view server software package.

The Tarantella software is ideally suited to the classroom 10 due to its low bandwidth requirements and minimal impact on the browsers 24,26. The Tarantella software converts the status information received from the target device 14 into a proprietary Tarantella protocol which requires much lower bandwidth than otherwise required by the status information as received from the target device 14. The Tarantella software sends the protocol to the browsers 24,26 over the network 12. The browsers 24,26 convert the protocol back into the status information as received from the target device 14 using a small JAVA plug-in. This allows the browsers 24,26 to be connected to the view server 18 using a low-bandwidth connection, such as a 56K modem.

The Tarantella software also provides the ability to have an application running in one Tarantella session viewed and controlled by another Tarantella session. For example, the instructor may run a privileged Tarantella session which can view and interact with another Tarantella session being run by the student.

The presentation server 20 preferably runs a presentation software package, such as Placeware, WebEx, or Centra Symposium. However, the presentation software package may be any software package that provides a capability to transmit at least a video presentation, such as a slide presentation, a web-cam presentation, or a electronic white board presentation. The presentation software package allows the presentation server 20 to transmit the lesson to the browsers 24,26 over the network 12.

Additionally, an audio connection between the instructor and the student is preferably provided to allow the student to ask questions and the instructor to answer the questions. This audio connection may be managed by the presentation server 20 or a separate teleconferencing system. For example, if the presentation software package does not also provide an integral audio connection between the instructor and the student, then a common teleconference call connection may be used to provide the audio connection. Alternatively, a chat connection may be substituted for or used in conjunction with the audio connection.

It is important to note that the video connection need only be unidirectional, while the audio connection is preferably bidirectional. In other words, while it may be important for the student to receive the lesson visually, there may be less need for the student to transmit video content. However, the audio connection and the chat connection are preferably bidirectional, thereby allowing the student to ask the instructor a question and receive an answer from the instructor.

As discussed above, the video connection may comprise one or more web-cam video connections. For example, the classroom 10 may include an instructor web-cam connection from the instructor to the student, thereby allowing the instructor to present the lesson in a traditional manner. Additionally, the classroom 10 may include a device web-cam connection from the target device 14 to the student. In limited situations, the device web-cam may be able to accomplish some of the functions of the RAD 16 and the view server 18, by allowing the student to see the target device 14 and its current physical condition.

Each web-cam connection is, by its very nature, a unidirectional video connection. Two web-cam connections are required to provide a bidirectional video connection. For example, in addition to the instructor web-cam, the classroom 10 may include a student web-cam connection from the student to the instructor. The student web-cam may be used to show the instructor the exact steps taken by the student, bypassing any influence other elements of the classroom 10 may exert. The instructor web-cam and the student web-cam combine to form one embodiment of the bidirectional video connection.

The RPC 22 allows the student to remotely turn the target device 14 on and off by cycling power to the target device 14. The RPC 22 is preferably a commonly available reboot strip that can be accessed through a LAN connection and/or a serial connection. The RPC 22 preferably takes power from a power source, such as an uninterruptible power supply (UPS) and has one or more power ports from which the target device 14 receives power.

The RPC 22 is preferably able to not only cycle power to the target device 14, but can also to turn power to the target device 14 off and on. Additionally, other elements of the classroom 10 may receive power through the RPC 22, such as the RAD 16, the view server 18, the presentation server 20, and the network hardware 28. For example, when the lesson is complete, the instructor may turnoff power to the entire classroom 10. In other words, the instructor may use the RPC 22 to “turn the lights off and go home”.

It can be appreciated that the classroom 10, may be located remotely with respect to the instructor and the student, since neither party needs physical access to the classroom 10. This allows the classroom 10 to be used for different lessons conducted by different instructors in different locations with very little turn-around time, since no portion of the classroom 10 needs to be shipped to the different locations. Additionally, this allows the classroom 10 to be located in a cost effective location where technical support is readily available.

Furthermore, any element of the classroom 10 may reside remotely with respect to other elements of the classroom 10. For example, the presentation server 20 may be hosted by a presentation service provider. The presentation service provider may specialize in such services and only provide the functionality of the presentation server 20. Thus, the presentation service provider may be appointed to operate the presentation server 20.

Therefore, a contrivance may be provided so that the student may access the presentation server 20. For instance, if the presentation server 20 is hosted by the presentation service provider, then the contrivance may comprise login information allowing the student to access the presentation service provider's facilities and receive the lesson from the presentation server 20. Such login information may be given to the student in any form, such as a letter, an email, a facsimile, or a notice posted on a website. The logon information may be presented to the presentation server or it may be presented to the web server which attempts to match the logon information with information stored in a back-end database. Otherwise, the contrivance may simply comprise the network hardware 28 and any required interconnections.

As described above, the web server may act as a gateway to the classroom 10. For example, the student may access and present the logon information to the web server. The logon information may be used by the web server to find one of a plurality of records stored in the back-end database, wherein each record stores information relating to each student. The web server may then activate and assign an appropriate target 14 device to each student and redirect the student browser 24 to the view server 18 and the presentation server 20 according to information stored in the record so that they can begin the lesson.

While the present invention has been described above, it is understood that other hardware and/or software components can be substituted depending on the functionality required. For example, the view server 18 and/or the presentation server 20 may also receive power from the RPC 22. Additionally, with a large number of students, there may be more than one view server 18 and/or presentation server 20. Furthermore, the buttons in the control area may be used to initiate a connection with the target device 14 through the RAD 16 and the view server 18. Additionally, any of the buttons in the control area may actually perform one or more operations and/or send one or more commands the view server 18. Finally, the RAD 16 and the RPC 22 may actually comprise a single device capable of performing the functionality of both. These and other minor modifications are within the scope of the current invention.

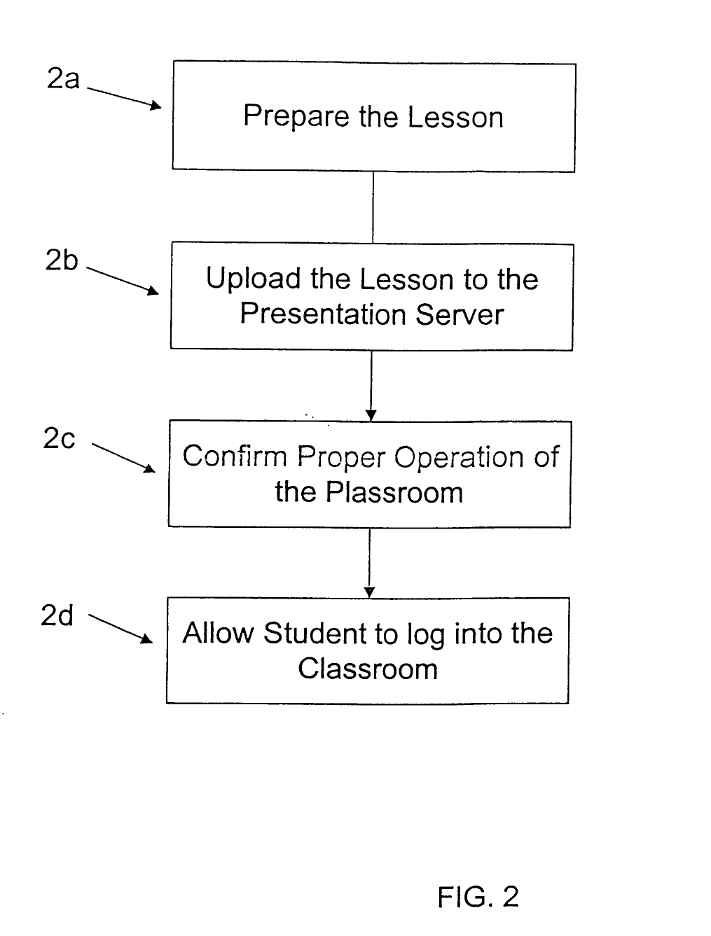

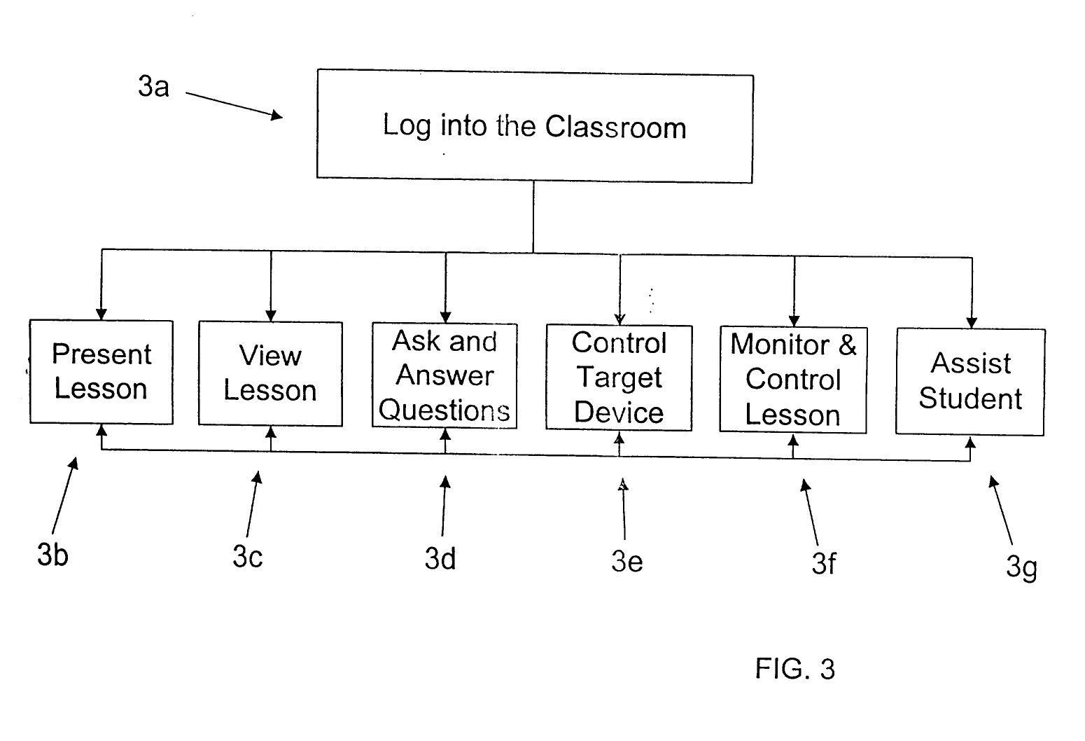

The flow charts of FIGS. 2 and 3 show the functionality and operation of a preferred implementation of the current invention in more detail. In this regard, some of the blocks of the flow charts may represent a module segment or portion of code of a program of the current invention which comprises one or more executable instructions for implementing the specified logical function or functions. In some alternative implementations, the functions noted in the various blocks may occur out of the order depicted. For example, two blocks shown in succession may in fact be executed substantially concurrently, or the blocks may sometimes be executed in the reverse order depending upon the functionality involved.

As shown in FIG. 2, the classroom 10 may be used to teach a lesson about configuring a NIC in a PC. In this case, the target device 14 is the PC and the NIC is the peripheral. The instructor prepares the lesson comprising a plurality of electronic slides, as depicted in step 2a. The instructor also prepares a lab exercise to reinforce the lesson. In this case, the lab exercise would encompass configuring the NIC and confirming that the PC can properly utilize the NIC. Then, the instructor uploads the slides to the presentation server 20, as depicted in step 2b. The instructor uses the instructor browser 26 to test the lesson and the lab exercise through the presentation server 20 and the view server 18, respectively, as depicted in step 2c. Once the instructor is finished preparing and testing the lesson, as described above, he or she allows the student to log into the classroom 10, as depicted in step 2d.

Referring to FIG. 3, shortly before the lesson is scheduled to begin, the student and the instructor log into the classroom 10 using the browsers 24,26, as depicted in step 3b. The student and the instructor log into the classroom 10 in any traditional manner commonly associated with network security. Once the student and the instructor have logged in, they are connected to the view server 18 and the presentation server 20. The instructor uses the instructor browser 26 to present the lesson through the presentation server 20, as depicted in step 3b. The student views the slides received from the presentation server 20 in the presentation area of the student browser 24, as depicted in step 3c. Any questions the student may have are asked and answered through the audio connection or the chat connection, as depicted in step 3d.

In order to perform the lab exercise, the student observers and controls the target device 14 through the RAD 16 and the view server 18 using the view area and the control area of the student browser 24, as depicted in step 3e. The student observes the status information received from and sends the commands to the target device 14 through the RAD 16 and the view server 18 using the view area of the student browser 24.

The instructor monitors and controls the lesson using the presentation area and the control area of the instructor browser 26, as depicted in step 3f. The instructor can also observe the student's progression through the lab exercise using the view area of the instructor browser 26 by initiating a connection with the view server 18 using the buttons in the control area of the instructor browser 26. Additionally, the instructor can assist the student in performing the lab exercise by taking control of the target device 14 through the RAD 16 and the view server 18 using the buttons in the control area of the instructor browser 26, as depicted in step 3g.

Having thus described a preferred embodiment of the invention, what is claimed as new and desired to be protected by Letters Patent includes the following:

1. A method for providing a virtual computer classroom operable to allow an instructor to present a lesson to at least one student over a network, the method comprising the steps of:
a) configuring at least one remote access device to allow remote observation of a target device to be used in the lesson; and
b) arranging access to a presentation server to allow the instructor to present the lesson over the network.

2. The method as set forth in claim 1, further comprising the step of supplying power to the target device through a remote power control device operable to control power to the target device upon direction from the student.

3. The method as set forth in claim 1, further comprising the step of connecting a view server to the remote access device and the network thereby allowing the student to receive status information relating to the target device using an internet browser.

4. The method as set forth in claim 1, wherein the instructor is located remotely to the student.

5. The method as set forth in claim 1, wherein the instructor is located remotely to the target device.

6. The method as set forth in claim 1, wherein the student is located remotely to the target device.

7. The method as set forth in claim 1, wherein the target device is selected from the group consisting of: a personal computer, a server, a switch, a router, a private branch exchange, and a personal data assistant.

8. The method as set forth in claim 7, wherein the target device includes an associated peripheral.

9. The method as set forth in claim 8, wherein the peripheral is selected from the group consisting of: a network interface card, an internal storage device, external storage device, and a printer.

10. The method as set forth in claim 1, wherein the presentation server is operable to provide video and audio connectivity between the instructor and the student.

11. The method as set forth in claim 1, further comprising the step of implementing an audio connection between the instructor and the student wherein the presentation server provides video content from the instructor to the student.

12. The method as set forth in claim 1, wherein the student can connect with the presentation server using an internet browser.

13. The method as set forth in claim 1, wherein the step of arranging access to the presentation server comprises appointing a presentation service provider to operate and allow the student to access the presentation server.

14. The method as set forth in claim 1, wherein the step of arranging access to the presentation server comprises configuring network hardware to allow the student to access the presentation server.

15. A method for providing a virtual computer classroom operable to allow an instructor to present a lesson to at least one student over a network, the method comprising the steps of:
a) configuring a remote access device to allow remote interaction with a target device to be used in the lesson;
b) connecting a view server to the remote access device and the network thereby allowing the student and the instructor to receive status information relating to the target device and send commands to the target device;
c) arranging access to a presentation server thereby allowing the instructor to present the lesson to the student over the network; and
d) implementing a connection between the instructor and the student thereby allowing the instructor and the student to ask and answer questions.

16. The method as set forth in claim 15, further comprising the step of supplying power to the target device through a remote power control device operable to control power to the target device upon direction from the student.

17. The method as set forth in claim 15, wherein the instructor is located remotely to the student.

18. The method as set forth in claim 15, wherein the instructor is located remotely to the target device.

19. The method as set forth in claim 15, wherein the student is located remotely to the target device.

20. The method as set forth in claim 15, wherein the target device is selected from the group consisting of: a personal computer, a server, a switch, a router, a private branch exchange, and a personal data assistant.

21. The method as set forth in claim 20, wherein the target device includes an associated peripheral.

22. The method as set forth in claim 21, wherein the peripheral is selected from the group consisting of: a network interface card, an internal storage device, external storage device, and a printer.

23. The method as set forth in claim 15, wherein the step of arranging access to the presentation server comprises appointing a presentation service provider to operate and allow the student to access the presentation server.

24. The method as set forth in claim 15, wherein the step of arranging access to the presentation server comprises configuring network hardware to allow the student to access the presentation server.

25. A virtual computer classroom operable to allow an instructor to present a lesson to at least one student over a network, the virtual computer classroom comprising:
at least one target device;
at least one remote access device operable to allow remote observation of the target device; and
a contrivance for allowing the student to access a presentation server operable to allow the instructor to present the lesson over the network.

26. The virtual computer classroom as set forth in claim 25, further comprising at least one remote power control device operable to cycle power to the target device.

27. The virtual computer classroom as set forth in claim 25, further comprising a view server operable to allow the student to access and interact with the remote access device using an internet browser in a manner that allows the instructor to observe the student.

28. The virtual computer classroom as set forth in claim 25, wherein the instructor is located remotely to the student.

29. The virtual computer classroom as set forth in claim 25, wherein the instructor is located remotely to the target device.

30. The virtual computer classroom as set forth in claim 25, wherein the student is located remotely to the target device.

31. The virtual computer classroom as set forth in claim 25, wherein the target device is selected from the group consisting of: a personal computer, a server, a switch, a router, a private branch exchange, and a personal data assistant.

32. The virtual computer classroom as set forth in claim 31, wherein the target device includes an associated peripheral.

33. The virtual computer classroom as set forth in claim 32, wherein the associated peripheral is selected from the group consisting of: a network interface card, an internal storage device, external storage device, and a printer.

34. The virtual computer classroom as set forth in claim 25, wherein the presentation server is operable to provide video and audio connectivity between the instructor and the student.

35. The virtual computer classroom as set forth in claim 25, further comprising an audio connection between the instructor and the student.

36. The virtual computer classroom as set forth in claim 25, wherein the student can connect with the presentation server using an internet browser.

37. The virtual computer classroom as set forth in claim 25, wherein the contrivance is selected from the group consisting of: a letter, an email, a facsimile, a notice posted on a website, a hub, a switch, and a router.

38. A virtual computer classroom operable to allow an instructor to present a lesson to at least one student over a network, the virtual computer classroom comprising:
at least one target device;
at least one remote access device operable to allow remote interaction with the target device;
a view server operable to allow the student and the instructor to access the remote access device;
a presentation server accessible by the student and operable to allow the instructor to present the lesson over the network; and
a connection between the instructor and the student operable to allow the student to ask the instructor a question about the lesson and allow the instructor to answer the question.

39. The virtual computer classroom as set forth in claim 38, further comprising at least one remote power control device operable to cycle power to the target device.

40. The virtual computer classroom as set forth in claim 38, wherein the instructor is located remotely to the student.

41. The virtual computer classroom as set forth in claim 38, wherein the instructor is located remotely to the target device.

42. The virtual computer classroom as set forth in claim 38, wherein the student is located remotely to the target device.

43. The virtual computer classroom as set forth in claim 38, wherein the target device is selected from the group consisting of: a personal computer, a server, a switch, a router, a private branch exchange, and a personal data assistant.

44. The system as set forth in claim 43, wherein the target device includes an associated peripheral.

45. The system as set forth in claim 44, wherein the associated peripheral is selected from the group consisting of: a network interface card, an internal storage device, external storage device, and a printer.

46. A virtual computer classroom operable to allow an instructor to present a lesson to at least one student over a network, the virtual computer classroom comprising:
a target device;
a remote power control device operable to cycle power to the target device upon direction from the student;
a remote access device operable to allow remote interaction with the target device;
a view server connected to the remote access device and operable to allow the student to receive status information from the target device and interact with the device through the remote access device over the network in a manner that allows the instructor to observe the student;
a presentation server accessible by the student and operable to allow the instructor to present the lesson to the student over the network; and
an audio connection between the instructor and the student operable to allow the student to ask the instructor a question about the lesson and allow the instructor to answer the question.
